(19) United States
(12) Patent Application Publication
(10) Pub. No.: US 2013/0142384 A1
(43) Pub. Date: Jun. 6, 2013

(54) ENHANCED NAVIGATION THROUGH MULTI-SENSOR POSITIONING

(71) Applicant: Eyal Ofek, Redmond,, WA (US)

(72) Inventor: Eyal Ofek, Redmond,, WA (US)

(73) Assignee: MICROSOFT CORPORATION, Redmond, WA (US)

(21) Appl. No.: 13/311,941

(22) Filed: Dec. 6, 2011

(51) Int. Cl. G06K 9/00; H04N 7/18

(52) U.S. Cl. 382/103; 348/158; 348/E07.085

(57) ABSTRACT

Enhanced navigation and positional metadata are provided based upon position determination utilizing data provided by multiple different systems of sensors. Infrastructure, or fixed sensor, data provides an initial location determination of humans and user-specific sensors that are co-located with their respective users provides identification of the users whose locations were determined. Navigation instructions provided based on the determined locations are enhanced by additional sensor data that is received from other user-specific sensors that are co-located with the users. Additionally, user privacy can be maintained by only utilizing sensor data authorized by the user, or by publishing fixed sensor data, identifying locations and movements of users, but not their identity, thereby enabling a user's computing device to match such information to the information obtained from user-specific sensors to determine the user's location.

### BACKGROUND

There exist many advantages, from the perspective of functionality that can be provided by a computing device, to knowing the physical location of entities. For example, computing devices can be utilized to track the location and movement of objects such as packages or files, either within a defined space, such as within a warehouse or office complex, or within an unbounded space, such as the shipment of packages around the world. As another example computing devices can be utilized to provide navigational aid to users based on the locations of those users.

Typically, the most common mechanism by which the location of an object or a user is determined is by the use of positioning systems, such as the ubiquitous Global Positioning System (GPS). GPS, however, does have inherent limitations, including the inability to determine the location of objects or people when they are inside of a building or a structure that otherwise interferes with the transmission and reception of GPS signals from GPS satellites. Additionally, location determination by GPS is purposefully inaccurate, except for military applications.

To determine the location of objects or users more precisely, such as within an enclosed space, other techniques have been developed. For example, if the enclosed space includes multiple wireless base stations providing wireless communications functionality, then the location of the device that can communicate with those wireless base stations can be accurately determined based on wireless signal triangulation. However, such wireless triangulation requires a precise mapping of the enclosed space, such as by accurately detecting the wireless signal strength from multiple ones of the wireless base stations and a myriad of locations within the enclosed space. Additionally, such wireless triangulation requires repeated updating of the mapping of the enclosed space as existing wireless equipment is removed, new wireless equipment is added, and other changes are made to the overall environment that can also affect the wireless signal strength. As another example, if the enclosed space includes security cameras or other like imaging devices that can provide an image feed, the locations and even orientiations of human users can be determined, often with a relatively high degree of accuracy, through analysis of those image feeds. However, such analysis requires facial recognition or other like techniques to be applied in order to identify individual human users captured by the image feeds and, as such, is often computationally expensive and inaccurate.

More recently, to determine the location of human users in an enclosed space, cooperative location determination mechanisms have been developed where the image feed from, for example, security cameras, is utilized to determine the locations of humans, and other sensors borne by the humans themselves, such as, for example, accelerometers, are utilized to identify specific ones of the humans whose locations are known, thereby avoiding prior difficulties such as, for example, facial recognition from the images captured by the security cameras. Such mechanisms are deemed to be “cooperative” since multiple sources of information, namely the security cameras in the accelerometers in the above example, are utilized cooperatively to determine the location of specific, individual human users. However, such cooperative location determination mechanisms do not take full advantage of the data that can be generated by computing devices that users often carry with them such as, for example, the ubiquitous cellular telephone. Additionally, such cooperative location determination mechanisms do not take advantage of the processing capabilities of computing devices that users often carry with them to aid such users. As yet another drawback, such cooperative location determination mechanisms do not provide adequate user privacy.

### SUMMARY

In one embodiment, sensory data acquired by a portable computing device that users carry with them can be combined with data acquired by existing infrastructure to accurately determine the location of individual users.

In another embodiment, users can control whether or not the sensory data acquired by the portable computing device that they carry with them is to be utilized to determine their location. To entice users to enable utilization of the sensory data acquired by the portable computing device that users carry with them, valuable functionality can be provided to the user in return, including the ability to navigate to and to locate other users within an enclosed space and the ability to navigate to and locate objects and items of interest.

In a further embodiment, sensory data acquired by the portable computing device that users carry with them can be utilized not only to aid in the determination of the location of those users, but can also have, superimposed thereon, navigational information providing the user with an “heads-up display”, thereby providing the user with more intuitive navigational instructions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system within which user location can be determined;

FIG. 2 is a block diagram of an exemplary mechanism for determining user location;

FIG. 3 is a block diagram of an exemplary presentation of navigational instructions;

FIG. 4 is a flow diagram of an exemplary mechanism for determining user location; and

FIG. 5 is a block diagram of an exemplary computing device.

### DETAILED DESCRIPTION

The following description relates to the provision of enhanced navigation and positional metadata based upon position determination utilizing data provided by multiple different systems of sensors. Infrastructure, or fixed sensor, data can provide an initial location determination of humans and user-specific sensors that are co-located with their respective users can provide an identification of the users whose locations were determined. The determined locations can be enhanced, or made more accurate, by additional sensor data that can be received from other user-specific sensors that are co-located with the users. Positional metadata, such as information regarding products or items the user is near or is oriented towards, can, likewise, be provided. Additionally, user privacy can be maintained by only utilizing sensor data authorized by the user, which can be enticed by the presentation of enhanced navigation capabilities, including enabling the user to meet-up with other users that have similarly authorized the use of sensor data and by directing the user to items of interest to the user. Alternatively, fixed sensor data, identifying locations and movements of users, but not their identity, can be published, and a user's computing device can match such information to the information obtained from user-specific sensors to determine a user's location.

For purposes of illustration, the techniques described herein are directed to video image feeds and accelerometer sensor data. Such references, however, are strictly exemplary and are not intended to limit the mechanisms described to the specific examples provided. Indeed, the techniques described are applicable to any sensor feeds, including radar or sonar feeds, infrared sensor feeds, compass, or other telemetry equipment feeds, stereo camera feeds, depth sensor feeds, the feeds from noise, vibration, heat and other like sensors, and other like sensor data. Consequently, references below to a “security camera”, “video camera”, “accelerometer” and the like are intended to be understood broadly to signify any type of sensor, since the descriptions below are equally applicable to other sensor data and are not, in any way, uniquely limited to only video cameras and accelerometer data.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

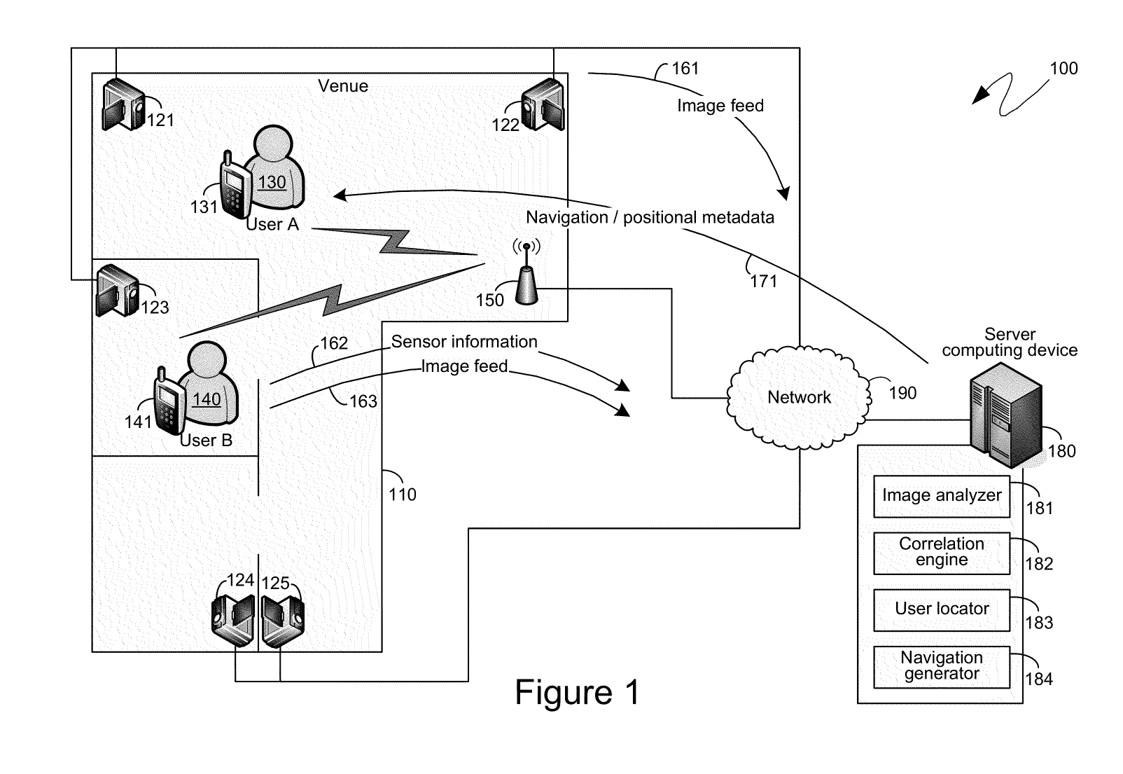

Turning to FIG. 1, an exemplary system 100 is shown, comprising a server computing device 180 that can receive sensory information from the venue 110 via the network 190 to which the server computing device 180 is communicationally coupled. In particular, in the exemplary system 100 of FIG. 1, the venue 110 is illustrated as having a video surveillance or security system that can comprise the video cameras 121, 122, 123, 124 and 125, all of which can be communicationally coupled, either directly or indirectly, such as through a centralized surveillance or security system hub, to the network 190. In addition, the venue 110 can comprise one or more wireless base stations, such as the wireless base station 150, that can maintain wireless communicational connections with one or more portable computing devices, such as, for example, the portable computing device 131 carried by the user 130 and the portable computing device 141 carried by the user 140. The wireless communication system offered by the venue 110, such as via the wireless base station 150, can likewise, be communicationally coupled to the network 190.

In one embodiment, an image feed 161 from the video cameras 121, 122, 123, 124 and 125 can be provided to, or accessed by, the server computing device 180. Similarly, sensor information 162 and image feed 163 from the mobile computing devices 131 and 141 in the venue 110 can, likewise, be provided to, or accessed by, the server computing device 180. The server computing device 180 can comprise an image analyzer 181 that can receive the image feed 161 and the image feed 163 and can analyze those image feeds to identify human users pictured in those image feeds. Server computing device 180 can also comprise a correlation engine 182 that can receive the sensor information 162 and, based on that sensor information, can identify specific ones of the human users that were identified with image analyzer 181 by correlating the sensor information 162 associated with mobile computing devices known to be carried by specific human users with the information gleaned from the image feeds 161 and 163 by the image analyzer 181. A user locator 183, which can also be part of the server computing device 180, can determine the location of specific ones of the human users based on the correlating information provided by the correlation engine 182 and the location information that can be provided by the image analyzer 181. The server computing device 180 can provide navigation information based on the locations of one or more users, such as determined by the user locator 183, and it can also provide positional metadata, such as information about products or services that the user may be near or may be oriented towards, again based on the determined location of the user. The navigation/positional information 171 can be provided to one or more of the users 130 and 140, such as via their mobile computing devices 131 and 141, respectively. Should navigation information be provided to a user, it can be generated by a navigation generator 184, which could also be part of the server computing device 180.

In another embodiment, which is not specifically illustrated by the system 100 of FIG. 1 so as to maintain illustrative simplicity, the correlation engine 182 and the user locator 183 need not execute on a server computing device, such as the server computing device 180, but instead can execute, individually, on one or more of the mobile computing devices co-located with the users, such as the mobile computing devices 131 and 141 carried by the users 130 and 140. More specifically, analysis of the image feed 161 provided by the video cameras 121, 122, 123, 124 and 125 can be performed by the image analyzer 181 on the server computing device 180. The image analyzer 181 can then make available its analysis, such as, for example, the motions of the individuals pictured in the image feed 161. An individual mobile computing device, such as the mobile computing device 131, can obtain such analysis and through its execution of a correlation engine 182, can correlate such analysis with the information being received from sensors that are part of the mobile computing device 131. The user locator 183, again executing on a mobile computing device, such as the mobile computing device 131, can then determine the location of the user 130 that is carrying the mobile computing device 131, based on the analysis obtained from the image analyzer 181 and the subsequent correlation performed by the correlation engine 182 executing on the mobile computing device. In such an embodiment, user identifying information, such as that which can be collected from the sensors of the user's mobile computing device, need not be transmitted, and can, instead, remain on the mobile computing device, thereby improving user privacy.

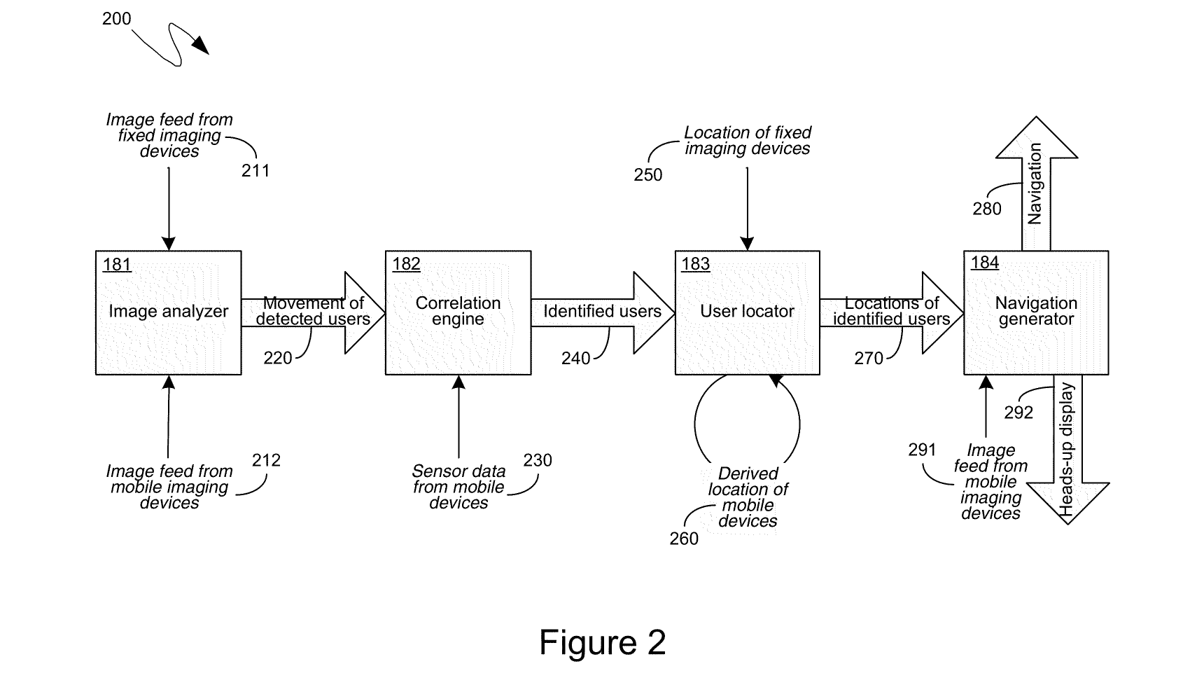

Turning to FIG. 2, the system 200 shown therein illustrates an exemplary processing that can be performed by components that can execute on a server computing device, such as the server computing device 180 that was illustrated in FIG. 1, or, individually, on one or more mobile computing devices, such as the mobile computing devices 131 and 141 that were also illustrated in FIG. 1. Initially, as shown, an image feed 211 from fixed imaging devices can be received by an image analyzer 181 executing on a server computing device. Because the image feed 211 can be from fixed imaging devices, such as, for example, the security cameras 121, 122, 123, 124 and 125 that were shown in FIG. 1, the image analyzer 181, in analyzing the image feed 211, can conclude that any movement detected across subsequent frames of the image feed is movement on the part of the object being imaged and not movement by the imaging camera itself. Additionally, because the image feed 211 can be from fixed imaging devices, the objects imaged by that image feed can have their location more easily identified since the location of the imaging device is fixed and known.

In one embodiment, the image analyzer 181 can analyze the image feed 211 to identify human users within the image feed 211 and detect motion on the part of those identified users. For example, the image analyzer 181 can apply known image analysis techniques to detect shapes within the image feed 211 that conform to, for example, human shapes, the shape of a vehicle a user might be in, the shape of a track-able feature on an object, the shape of the mobile computing device in the user's hand, and the like. As another, the image analyzer 181 can apply known image analysis techniques, such as, for example, the analysis of adjacent frames of the image feed 211, to detect movement. The movement detected by the image analyzer 181 can, as will be described in further detail below, be correlated with sensor data from sensors that can detect, or would be affected by, the sort of movement that was detected by the image analyzer 181.

Once the image analyzer 181 has identified human users in the image feed 211 and has detected their movement, the detected users and their movement, in the form of data 220, can then be provided to the correlation engine 182. The correlation engine 182 can receive, or otherwise obtain, sensor data 230 from mobile computing devices that are co-located with specific users and can correlate this sensor data 230 with the movement identified by the image analyzer 181 that was provided as part of the data 220.

The sensor data 230 received by the correlation engine 182 can be provided by the mobile computing devices 131 and 141 that are carried by the users 130 and 140, respectively, as shown in FIG. 1. Because the sensor data can be from mobile computing devices that are co-located with specific users, and which can be associated with specific users, it can be utilized, by the correlation engine 182, to identify specific users from among those users whose movement was detected by the image analyzer 181, and which was provided to the correlation engine 182 as part of the data 220. Additionally, or as an alternative, mobile computing devices can comprise sensors other than motion sensors that can also provide input to the correlation engine 182. For example, the sensor data 230 can comprise near-field sensor data, such as short-range wireless signals, audio signals captured by a microphone or other like information that, due to a limited range within which it can be acquired, can be utilized to identify a user's location. For example, if the image analyzer 181 detected a user near a kiosk with short-range wireless communications, such as for wirelessly providing data to users using the kiosk, and a user's mobile computing device detected that kiosk's short-range wireless communications, then such a detection can be part of the sensor data 230 that can be provided to the correlation engine 182.

In one embodiment, mobile computing devices can be associated with specific users through a registration process, or other like mechanism, by which a user registers their mobile computing device, links it with an identification of the user and otherwise provides permission for their sensor data 230 to be utilized. For example, the user could provide identifying information of the mobile computing device, such as its MAC address or other like identifier or, alternatively, as another example, the user could simply install an application program on the mobile computing device that could obtain the relevant information from the mobile computing device and associate it with the user. As yet another alternative embodiment, as indicated previously, the correlation engine 182 can execute on the mobile computing device itself, obviating the need for a user to register. Instead, the correlation engine 182, executing on the user's mobile computing device, could simply access the sensor data 230 locally, after receiving the user's permission.

The data 220 that can be provided, by the image analyzer 181, to the correlation engine 182 can comprise movement information of users detected by the image analyzer 181. The sensor data 230 that can be received by the correlation engine 182 can, similarly, comprise movement information, though in the case of the sensor data 230, the movement information provided can be linked to specific, individual users. For example, the data 220 can indicate that one identified user was walking with a specific gait and step, thereby resulting in that user exhibiting an up-and-down movement having a specific periodicity and other like definable attributes. The correlation engine 182 can then reference the sensor data 230 to determine if any one of the sensor data 230 is of an accelerometer showing the same up-and-down movement at the same time. If the correlation engine 182 is able to find such accelerometer data in the sensor data 230, the correlation engine 182 can correlate the accelerometer that generated that data with the individual user exhibiting the same movement, as indicated in the data 220. Since the accelerometer can be part of a mobile computing device that can be associated with, or registered to, a specific user, the individual user that was exhibiting that movement, as determined by the image analyzer 181 can be identified as the same user that is associated with, or registered to, the mobile computing device whose accelerometer generated the correlated data. In such a manner, the correlation engine 182 can utilize the sensor data 230 and the data 220 received from the image analyzer 181 to identify the users whose movement was detected by the image analyzer 181. The correlation engine 182 can then provide data 240, comprising such identification of specific users, to the user locator 183.

The user locator 183 can then determine the locations of the users identified by the correlation engine 182 based upon the position of those users, as seen in the image feed 211 that was received by the image analyzer 181 and the location of those known, fixed, imaging devices, which can be provided as information 250 to the user locator 183. In one embodiment, the user locator 183 can utilize additional information that can be received from mobile computing devices to provide additional precision to already determined user locations, or to extend the derivation of user locations to previously undetected users. For example, a user, whose location can have been identified by the image analyzer 181 and the correlation engine 182, can be using their mobile computing device to itself capture an image feed of a portion of an area proximate that user. Such an image feed from the mobile computing device can be part of the image feed 212 that can be received by the image analyzer 181. In one embodiment, the image analyzer 181 can analyze the image feed 212 in the same manner as it does the image feed 211, which was described in detail above. The image feed 212 can, thereby, provide further information about users whose movements may have already been detected as part of the analysis of the image feed 211 or, alternatively, the image feed 212 can provide information about previously undetected users, such as users that may not have been within the field of view of the imaging devices providing the imaging feed 211. The correlation engine 182 can then utilize the information from the image feed 212, as analyzed by the image analyzer 181, to identify any users that may be within the field of view of that image feed 212, such as in the manner described in detail above. Such information can be used by the user locator 183 to determine the locations of users including determining a second location for known users that can be used to double-check, or render more precise, an already determined location for such users, and also including determining locations of previously undetected users, such as users that may not have been within the field of view of the imaging devices providing the imaging feed 211. For users that were in the field of view of the imaging devices providing the imaging feed 211, but which may have been at an odd angle to the imaging device, or were located without any visible landmarks nearby, their position can be difficult to accurately determine from the images captured by such an imaging device, as will be known by those skilled in the art. In such a case, a refined location of that user that can be determined by the user locator 183 from the image feed 212 coming from another user's mobile computing device.

The user locator 183 is illustrated as utilizing the derived location 260 of the mobile computing devices in a circular, or feedback manner to account for the embodiments described above. In particular, by determining the location of some of the identified users provided by the correlation engine 182 in the data 240, the user locator 183 can derive the locations 260 of the mobile computing devices of those users. Those locations 260 can then be utilized, together with the image feed 212 from those mobile computing devices to determine the locations of other, previously unknown users, or to refine the already determined locations of known users, as indicated, thereby providing a feedback loop.

Subsequently, data 270 comprising the locations of identified, specific users can be provided, by the user locator 183, to the navigation generator 184. As indicated previously, in one embodiment, user privacy can be addressed by enabling users to choose whether or not data from their mobile computing devices, such as image data or sensor data, is to be made available to the system 200 to enable the system 200 to determine that user's location. As an incentive to entice users to participate, enable data from their mobile computing devices to be utilized, and allow their location to be determined, users can be offered navigation or other location-specific features and functionality that can be made available by the system 200, such as the provision of positional metadata. For example, if the venue in which the user is located is a retail venue such as, for example, a shopping mall, grocery store, or other like retailer, the user's location, as determined by the user locator 183 and as provided to the navigation generator 184 in the form of data 270, can be compared to the location of known items in that retail venue and the navigation instructions 280 can be provided to such a user to guide them to those items. As a specific implementation, for example, if the venue in which the user is located is a grocery store, the user could be afforded the opportunity to enter items that they wish to purchase such as, for example, a grocery list, and as the image analyzer 181, the correlation engine 182 and the user locator 183 continually track the user's location throughout the grocery store, the navigation generator 184 can continually generate navigation instructions 280 to the user continually guiding that user to the next item on their grocery list. As another specific implementation, for example, if the venue in which the user is located is a shopping mall, the user could be afforded the opportunity to register specific types of products that they are interested in, or specific retailers from which the user often purchases items, and if the user's location, as determined by the image analyzer 181, the correlation engine 182 and the user locator 183, is proximate to a product that is currently being promoted such as, for example, by being placed on a special sale, or, alternatively, that the users location is proximate to a specific retailer that is currently hosting a promotional event, then the navigation generator 184 could generate navigation instructions 280 to guide the user to such a product with such a promotional event.

As an example of the navigational functionality that can be offered by the navigation generator 184, the navigation generator 184 can utilize the locations of identified users, provided by the data 270, to enable two or more users to find one another, such as, for example, in a crowded venue. More specifically, the navigation generator 184 can utilize existing dynamic endpoint navigation techniques to provide navigation instructions 280 to each of the two or more users that are attempting to find one another. Dynamic endpoint navigation provides continuously updated navigation when the location of the destination can be continuously changing, such as when the endpoint of the navigation is, itself, moving to, for example, meet up with the user receiving the navigation instructions. One example of dynamic endpoint navigation is provided in co-pending U.S. patent application Ser. No. 13/052,093, filed on Mar. 20, 2011 and assigned to the same assignee as the present application, the contents of which are hereby incorporated by reference, in their entirety and without limitation, for any disclosure relevant to the descriptions herein.

In one embodiment, the navigation generator 184 can utilize an image feed 291 that is being received from a mobile computing device associated with the user to whom the navigation generator 184 is providing navigation functionality in order to provide the user with a “heads-up” display 292. In particular the heads-up display 292 can superimpose on the image feed 291 the navigational instructions being generated by the navigation generator 184. Additionally, the image feed 291 can be the same image feed 212 that can be utilized by the image analyzer 181, the correlation engine 182 and the user locator 183, such as in the manner described in detail above, to improve, or extend, the user locating capabilities of the system 200.

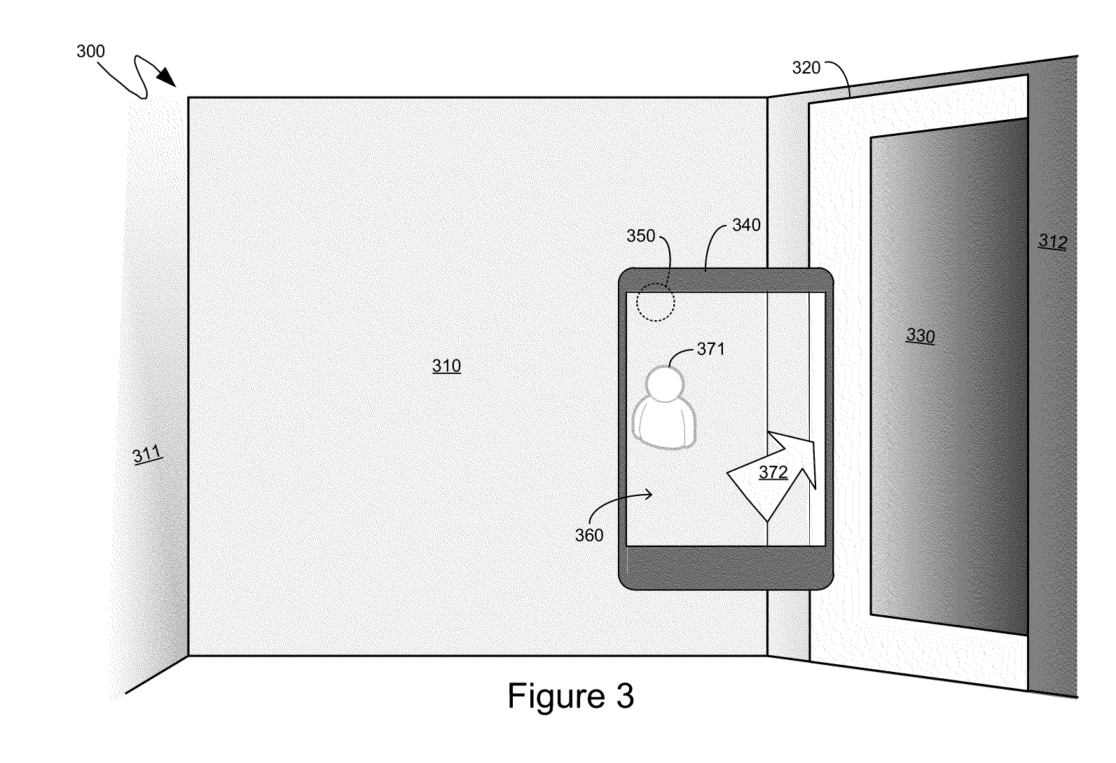

Turning to FIG. 3, the system 300 shown therein illustrates a simplified example of how the heads up display 292, as shown in FIG. 2, can provide navigational instructions to a user. In the system 300 of FIG. 3, the mobile computing device 340 comprises a display 360 and an image capture device 350, such as a video camera. A user of the mobile computing device 340 can be using the image capture device 350 to capture an image feed that can be provided to a user locating system, such as the system 200 shown in FIG. 2 and described in detail above. Additionally, in one embodiment, the image feed being captured by the image capture device 350 can further be displayed on the display device 360 of the mobile computing device 340.

The system 300 of FIG. 3 is illustrated from the perspective of a user of the mobile computing device 340 standing in a room having walls 310, 311 and 312, and an open doorway 320 in the wall 312 through which a wall 330 that is adjacent to the wall 312 can be seen. The user of the mobile computing device 340 can be sharing the image feed being captured by the image capture device 350 with the system such as that described in detail above and can have requested guidance to another user whose location is unknown to the user of the mobile computing device 340. In one embodiment, navigational instructions can be provided to the user of the mobile computing device 340 as a heads-up display that can be displayed on the display 360. Thus, for example, as illustrated by the system 300 of FIG. 3, the display 360 can comprise not only the walls 310 and 312 and the doorway 320 as imaged by the image capture device 350, but can further comprise, superimposed thereon, a silhouette of a user 371 to which navigational instructions can be provided and navigational instructions themselves such as, for example, the arrow 372 indicating to the user of the mobile computing device 340 that they are to proceed through the open doorway 320. In such a manner, the user of the mobile computing device 340 can be provided not only with navigational instructions, such as the arrow 372, but also with the location of their destination, such as the user 371, even though that location can be blocked by a wall, such as the wall 310. Thus, the heads up display 360 can, in essence, enable the user of the mobile computing device 340 to “see” the user 371 through the wall 310.

The location of the user 371, displayed in the heads up display, can be determined in the manner described in detail above including, for example, via the contributions of other users utilizing their mobile computing devices in the same manner as the user of the mobile computing device 340, thereby capturing image feeds that can be utilized to supplement, or extend, the user location capabilities enabled via the image feeds from fixed location imaging devices, such as security cameras. Thus, if the user of the mobile computing device 340 moves the mobile computing device such that it is oriented in a different direction, then the silhouette of the user 371 can, likewise move in the display 360 so that the user 371 is continuously represented in their determined location, as it would be viewed “through” the mobile computing device 340. Similarly, the arrow 372 can, likewise, be redrawn so that it points in the direction of the doorway 320, as it would be seen through the mobile computing device 340. In one embodiment, for elements that are not within the field of view of the image capture device 350, and are not displayed within the display 360, an indicator can be displayed within the display 360 to indicate, to the user of the mobile computing device 340, that they should change the direction in which the mobile computing device 340 is directed, such as by turning it, in order to have the missing elements visualized within the heads up display. In such a manner the display 360 can provide an “augmented reality” comprising not only what is seen “through” the mobile computing device 340, but also additional elements that cannot be seen by a user, such as another user located behind one or more walls from the user of the mobile computing device 340, or directional instructions and indicators, such as the arrow 372.

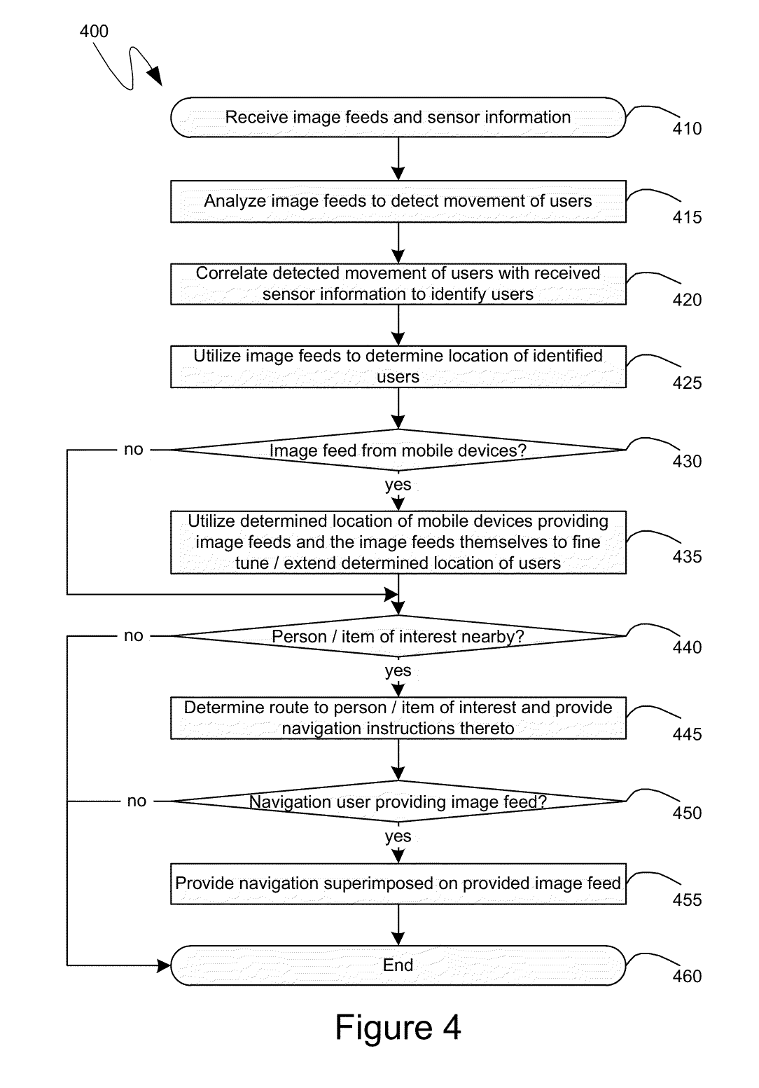

Turning to FIG. 4, the flow diagram 400 shown therein illustrates an exemplary series of steps that can be performed to enable the user location determinations described in detail above. Initially, at step 410, image feeds and sensor information can be received including, for example, image feeds from imaging devices whose location is fixed such as, for example, security cameras, and image feeds from imaging devices whose location can be dynamic such as, for example, mobile computing devices. Such mobile computing devices can also provide the sensor information that is received at step 410 which can include, for example, accelerometer censor information or other like sensor information that can detect changes in motion and direction. Subsequently, at step 415, the image feeds received at step 410 can be analyzed to identify users therein and their movements, such as through known image processing and filtering techniques. At step 420, the detected users and movements can be correlated with the sensor information that was received at step 410 to determine the identity of the users that were detected at step 415. Subsequently, at step 425, the image feeds received at step 410 can be utilized to determine the location of the users whose identity was determined at step 420 such as, for example, by reference to known landmarks or other points identifiable in the image feeds received at step 410.

If the image feeds received at step 410 include image feeds from mobile computing devices, or other like devices whose location can be changing and whose location can be tied to that of a user with which those devices are associated, as can be determined at step 430, then processing can proceed to step 435 where the location of those mobile computing devices providing those image feeds can be determined with reference to the determined locations of the users with which those mobile computing devices are associated, as those users' locations were determined at step 425. Once the location of the mobile computing devices providing the image feeds is known, step 435 can proceed to utilize the information provided by the image feeds of those mobile computing devices to either increase the accuracy of the locations of users determined at step 425 or to identify users that were not previously detected at step 415. Processing can then proceed to step 440. Conversely, if it is determined, at step 430, that there were no image feeds received from mobile computing devices, then processing can skip step 435 and proceed to step 440.

At step 440, a determination can be made, based on the locations of the users determined at steps 425 and 435, as to whether there are any items of interest to those users that approximate to their location or, alternatively, whether any one of the users whose locations were determined have expressed an interest in being navigated to at least one other user whose location was also determined. If there are no items of interest nearby, and no other user to which navigation instructions are to be provided, then the relevant processing can end at step 460. Alternatively, processing can proceed to step 445 where a route can be determined from the user whose location was identified to the other user or item of interest and navigation instructions can be generated and provided. If the user receiving the navigation instructions is capturing an image feed, such as through an image capturing device that is part of the mobile computing device being utilized by such user, as determined at step 450, then the navigation instructions of step 445 can be provided, at step 455, in the form of a heads-up display, where the navigation instructions can be superimposed on the image feed being captured by the user. The relevant processing can then end at step 460. Conversely, if, at step 450, it is determined that the user receiving the navigation instructions of step 445 is not providing, or capturing, an image feed, then the relevant processing can end at step 460.

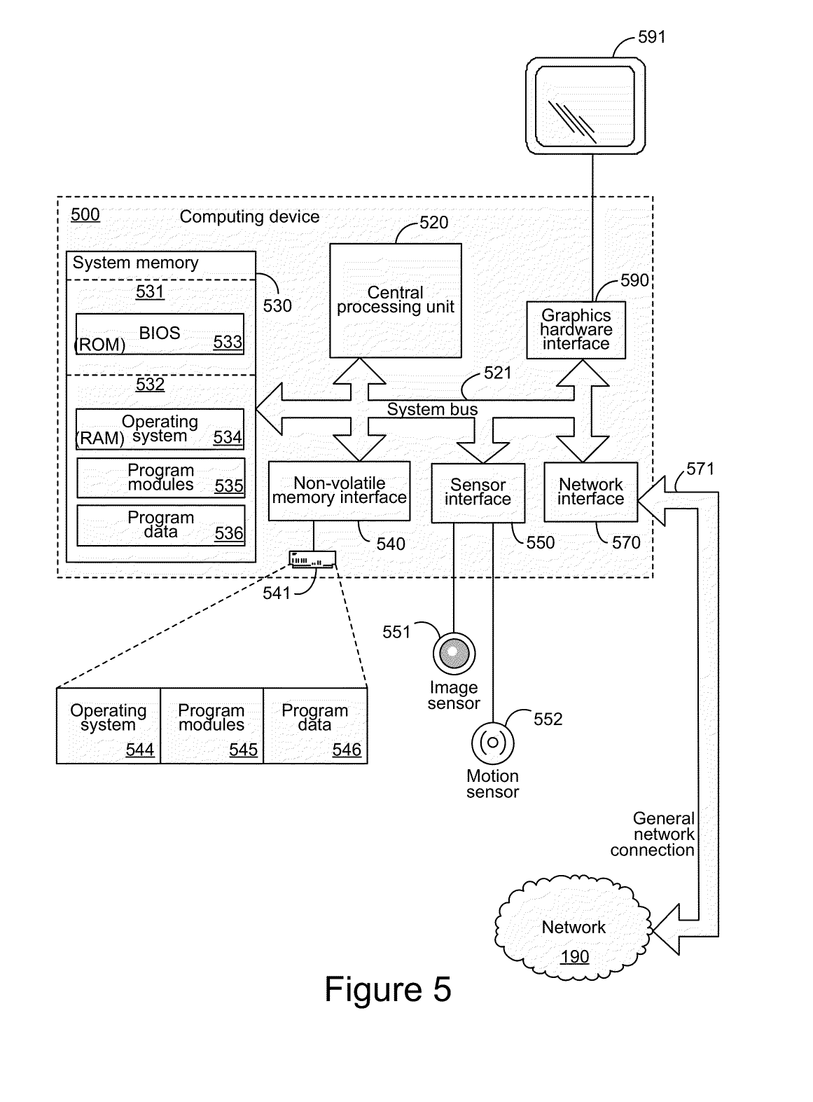

Turning to FIG. 5, an exemplary computing device 500 is illustrated upon which, and in conjunction with which, the above-described mechanisms can be implemented. The exemplary computing device 500 can be any one or more of the mobile computing devices 131 and 141 or the server computing device 180, or even the security cameras 121, 122, 123, 124 and 125, all of which were illustrated in FIG. 1 and referenced above. The exemplary computing device 500 of FIG. 5 can include, but is not limited to, one or more central processing units (CPUs) 520, a system memory 530, that can include RAM 532, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, such as for the display of graphics and visual user interfaces, the graphics hardware including, but not limited to, a graphics hardware interface 590 and a display device 591. Additionally, the computing device 500 can also include one or more sensors, such as an image sensor 551 for capturing images and image feeds, and a motion sensor 552 for detecting motion of the computing device 500. The image sensor 551 can be a video camera, infrared camera, radar or sonar image sensor or other like image sensors. Similarly, the motion sensor 552 can be an accelerometer, a GPS sensor, a gyroscope, or other like motion-detecting sensors. Sensors, such as the image sensor 551 and the motion sensor 552 can be communicationally coupled to the other elements of the computing device 500 via a sensor interface 550 that can be communicationally coupled to the system bus 521.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and the aforementioned RAM 532. A basic input/output system 533 (BIOS), containing the basic routines that help to transfer information between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates the operating system 534 along with other program modules 535, and program data 536.

The computing device 500 may also include other removable/non-removable, volatile/nonvolatile computer storage media. By way of example only, FIG. 5 illustrates the hard disk drive 541 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 536. Operating system 544, other program modules 545 and program data 546 are given different numbers hereto illustrate that, at a minimum, they are different copies.

The computing device 500 can operate in a networked environment using logical connections to one or more remote computers. The computing device 500 is illustrated as being connected to the general network connection 571 through a network interface or adapter 570, which can be, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 571. It will be appreciated that the network connections shown are exemplary and other means of establishing a communications link between computing devices may be used.

As can be seen from the above descriptions, mechanisms for providing enhanced navigation capabilities based upon position determination from multiple different systems of sensors have been provided. In view of the many possible variations of the subject matter described herein, we claim as our invention all such embodiments as may come within the scope of the following claims and equivalents thereto.

We claim:

1. One or more computer-readable media comprising computer-executable instructions for determining users' physical locations, the computer-executable instructions performing steps comprising:
detecting movement of unidentified users in one or more image feeds received from one or more fixed location imaging devices, whose location remains invariant;
correlating the detected movement with one or more motion sensor data from one or more mobile computing devices carried by one or more users;
identifying at least some of the unidentified users based on the correlating;
determining physical locations for the identified users from the one or more image feeds received from the one or more fixed location imaging devices;
receiving image feeds from mobile computing devices carried by at least some of the identified users whose physical locations were determined; and
performing the detecting, the correlating, the identifying and the determining with the received image feeds from the mobile computing devices.

2. The computer-readable media of claim 1, wherein the identifying performed with the received image feeds from the mobile computing devices identifies previously unidentified users.

3. The computer-readable media of claim 1, wherein the determining physical locations performed with the received image feeds from the mobile computing devices determines a more accurate physical location than that previously determined.

4. The computer-readable media of claim 1, comprising further computer-executable instructions for providing navigational instructions to a first user from among the identified users whose physical locations were determined, the navigational instructions being based on the determined location of the first user.

5. The computer-readable media of claim 4, wherein the navigational instructions direct the first user to an item determined to be of interest to the first user that is in a same venue as the fixed location imaging devices.

6. The computer-readable media of claim 4, comprising further computer-executable instructions for providing navigational instructions to a second user, also from among the identified users whose physical locations were determined, the navigational instructions being based on the determined physical location of the second user, the navigational instructions to the second user being provided concurrently with the navigational instructions to the first user, wherein the navigational instructions provided to the first user guide the first user to the second user, and wherein further the navigational instructions provided to the second user guide the second user to the first user.

7. The computer-readable media of claim 4, wherein the first user is one of the at least some of the identified users that are carrying the mobile computing devices from which image feeds are being received, and wherein further the computer-executable instructions for providing the navigational instructions comprise computer-executable instructions for generating heads-up navigational instructions in accordance with an orientation of the first user, as evidenced by the image feed being generated by the first user's mobile computing device, the generated heads-up navigational instructions to be superimposed over the image feed being generated by the first user's mobile computing device.

8. The computer-readable media of claim 7, comprising further computer-executable instructions for providing a heads-up graphical representation of a second user in accordance with a determined physical location of the second user and in accordance with the orientation of the first user, as evidenced by the image feed being generated by the first user's mobile computing device, the heads-up graphical representation of the second user to be superimposed over the image feed being generated by the first user's mobile computing device.

9. The computer-readable media of claim 1, wherein every one of the one or more users, from whose mobile computing devices the one or more sensor data is received, have previously authorized usage of the one or more sensor data to locate the one or more users.

10. A method for determining users' physical locations, the method comprising the steps of:
detecting movement of unidentified users in one or more image feeds received from one or more fixed location imaging devices, whose location remains invariant;
correlating the detected movement with one or more motion sensor data from one or more mobile computing devices carried by one or more users;
identifying at least some of the unidentified users based on the correlating;
determining physical locations for the identified users from the one or more image feeds received from the one or more fixed location imaging devices;
receiving image feeds from mobile computing devices carried by at least some of the identified users whose physical locations were determined; and
performing the detecting, the correlating, the identifying and the determining with the received image feeds from the mobile computing devices.

11. The method of claim 10, wherein the identifying performed with the received image feeds from the mobile computing devices identifies previously unidentified users.

12. The method of claim 10, wherein the determining physical locations performed with the received image feeds from the mobile computing devices determines a more accurate physical location than that previously determined.

13. The method of claim 10, further comprising the steps of providing navigational instructions to a first user from among the identified users whose physical locations were determined, the navigational instructions being based on the determined location of the first user.

14. The method of claim 13, wherein the navigational instructions direct the first user to an item determined to be of interest to the first user that is in a same venue as the fixed location imaging devices.

15. The method of claim 13, further comprising the steps of providing navigational instructions to a second user, also from among the identified users whose physical locations were determined, the navigational instructions being based on the determined physical location of the second user, the navigational instructions to the second user being provided concurrently with the navigational instructions to the first user, wherein the navigational instructions provided to the first user guide the first user to the second user, and wherein further the navigational instructions provided to the second user guide the second user to the first user.

16. The method of claim 13, wherein the first user is one of the at least some of the identified users that are carrying the mobile computing devices from which image feeds are being received, and wherein further the providing the navigational instructions comprises generating heads-up navigational instructions in accordance with an orientation of the first user, as evidenced by the image feed being generated by the first user's mobile computing device, the generated heads-up navigational instructions to be superimposed over the image feed being generated by the first user's mobile computing device.

17. The method of claim 16, further comprising the steps of providing a heads-up graphical representation of a second user in accordance with a determined physical location of the second user and in accordance with the orientation of the first user, as evidenced by the image feed being generated by the first user's mobile computing device, the heads-up graphical representation of the second user to be superimposed over the image feed being generated by the first user's mobile computing device.

18. The method of claim 10, wherein every one of the one or more users, from whose mobile computing devices the one or more sensor data is received, have previously authorized usage of the one or more sensor data to locate the one or more users.

19. A mobile computing device comprising:
a motion sensor detecting the mobile computing device's motion;
an image sensor capturing an image feed of an area surrounding the mobile computing device;
a network interface transmitting the motion detected by the motion sensor and the image feed captured by the image sensor; and
a display displaying navigational instructions from a current location of the mobile computing device to a destination, the current location of the mobile computing device having been determined by reference to the mobile computing device's motion as detected by the motion sensor.

20. The mobile computing device of claim 20, wherein the display further displays the image feed being captured by the image sensor and a heads-up graphical representation of a second user superimposed over the image feed in accordance with a determined physical location of the second user and in accordance with the orientation of the mobile computing device, as evidenced by the image feed, and wherein further the displayed navigational instructions comprise heads-up navigational instructions that are also superimposed over the image feed in accordance with the orientation of the mobile computing device, as evidenced by the image feed.
